(19) United States
(12) Patent Application Publication
(10) Pub. No.: US 2007/0032928 A1
(43) Pub. Date: Feb. 8, 2007

(54) Vehicle recorder to capture continuous images in the vicinity of an accident scene before and after the accident happens

(76) Inventor: Yasuo Kuwahara, Taipei (JP)

Correspondence Address: G. LINK Co., LTD, 3550 Bell Road, Minooka, IL, 60447, US

(21) Appl. No.: 11/198,852

(22) Filed: Aug. 8, 2005

(51) Int. Cl. G06F 19/00

(52) U.S. Cl. 701/35; 340/438; 348/148

(57) ABSTRACT

A vehicle recorder includes a first accident symptom detector for detecting an accident symptom and generating a first direction signal corresponding to a position relation between the first accident symptom detector and the accident symptom, a steering device coupled to the first accident symptom detector for performing a steering operation according to the first direction signal, an image capturing device installed on the steering device and coupled to the first accident symptom detector for capturing images continuously for a predetermined period of time according to the first direction signal and a memory for storing the continuous images captured by the image capturing device during the predetermined period of time.

### BACKGROUND OF THE INVENTION

1. Field of the Invention

The present invention is related to a vehicle recorder and particularly to a vehicle recorder to capture continuous images in the vicinity of an accident before and after the accident happens.

2. Brief Description of the Related Art

Rapid economic development brings to unceasing increase of vehicles but uprising number of cars comes along with increase of car accidents inevitably. Once a car accident happens, how to attribute the liability correctly and exactly is a problem bothering parties concerned. Thus, it is required a processing procedure available for the parties concerned to follow commonly before it is decided which party has to be responsible for the liability.

Referring to FIG. 1, a flow chart with regard to the conventional procedure for processing a car accident is illustrated. The processing procedure 100 is further divided into two main sub-procedures, personal accident sub-procedure and article accident sub-procedure. The processing procedure 100 includes following steps:

Step 102: Starts (a car accident happens);

Step 104: The scene of the car accident is inspected and statements of the parties concerned are listened (The processing procedure 100 is divided into the article accident sub-procedure from step 106 and the personal accident sub-procedure from step 156 hereinafter.);

Step 106: Identity is examined by insurance company and negotiation is made with the insurance company;

Step 108: Examination is engaged and persons in duty are sent on mission (For example, appraising personnel is sent to the scene of accident.);

Step 110: Sharing proportion of liability of fault is evaluated and calculated.

Step 112: damaged cars in the accident are delivered to the shop for repair and then go to step 109.

Step 156: The scene of accident is analyzed and the accident is investigated.

Step 158: The parties concerned propose different opinions.

Step 160: Negotiation is conducted between the parties concerned.

Step 162: If the parties concerned have reached an agreement? If it is “Yes”, go back step 106. If it is “No”, go to step 164;

Step 164: Make sure witness and evidence being secured.

Step 166: An accident appraisal institution is assigned.

Step 168: If the parties concerned agree report made by the accident appraisal institution? If it is “Yes”, go to step 190 and if it is “No”, go to step 170.

Step 170: A legal proceeding is taken; and

Step 190: End.

Most of the steps in the processing procedure 100 are visible without arguments and they are implemented easily such as step 104 (The scene of the car accident is inspected and statements of the parties concerned are listened.) and step 166 (An accident appraisal institution is assigned.). However, the step 164 (Make sure witness and evidence being secured.) is difficult to control. It is because the witness and the evidence are probably unwilling to bear testimony due to being afraid of getting trouble even if they have promised to bear testimony. Hence, the assigned accident appraisal institution in step 166 and court in charge of the proceeding in step 170 are unable to make a proper decision for the car accident owing to no sufficient evidences are available. That means the harmed party is unable to acquire the deserved compensation.

### SUMMARY OF THE INVENTION

In order to overcome the preceding deficiencies, an object of the present invention is to provide a vehicle recorder to capture continuous images in the vicinity of an accident before and after the accident happens.

Accordingly, a vehicle recorder to capture continuous images in the vicinity of an accident before and after the accident happens according to the present invention includes a first accident symptom detector, being used for detecting an accident symptom and generating a first position signal, which provides a positional relation between the first accident symptom detector and the accident symptom; a steering device, being coupled to the first accident symptom detector for implementing a movement of steering in accordance with the first position signal; an image capturing device, being mounted to the steering device and coupled to the first accident symptom detector for capturing images continuously in a predetermined time duration; and a memory, being coupled to the image capturing device for storing the continuous images captured by the image capturing device in the predetermined time duration.

Furthermore, a vehicle recorder for a transportation tool to capture continuous images in the vicinity of an accident before and after the accident happens according to the present invention includes an accident symptom detector, being used for detecting an accident symptom and generating an accident symptom signal; a position detector, being used for detecting an object nearest the transportation in accordance with the accident symptom signal and generating a position signal, which provides a position relation between the object and the transportation tool; a steering device, being coupled to the position detector for implementing a movement of steering based on the position signal; an image capturing device, being mounted to the steering device and coupled to the position detector for capturing images continuously in a predetermined time duration according to the position signal; and a memory, being coupled to the image capturing device for storing the continuous images captured by the image capturing device in the predetermined time duration.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a flow chart illustrating the conventional process being treated for a car accident;

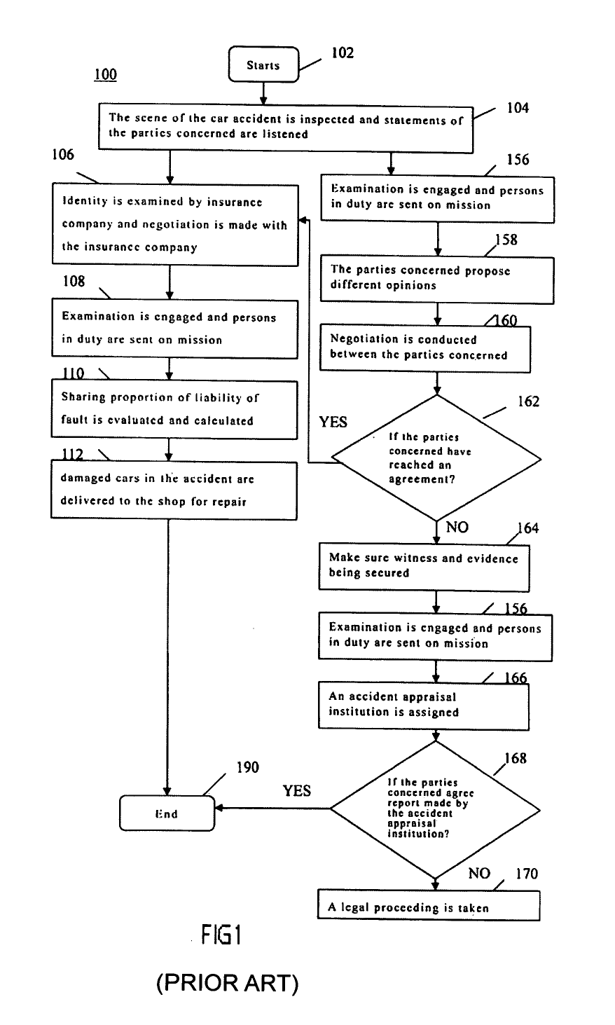

FIG. 2 is a top view of the first embodiment of a vehicle recorder according to the present invention;

FIG. 3 is a top view of the second embodiment of a vehicle recorder according to the present invention; and

FIG. 4 is a top view of the third embodiment of a vehicle recorder according to the present invention

### DETAILED DESCRIPTION OF THE INVENTION

Generally, a symptom always appears prior to a car accident happening.

For instance, a deafening noise created by friction of tires against the ground or continuous lasting warn of horn can be regarded as the accident symptom occurring before a car accident happening. Accordingly, the specific feature of the accident symptom is utilized in a vehicle recorder of the present invention. That is, the vehicle recorder has detected the accident symptom and continuous images around the accident symptom are recorded in advance. Equivalently, those recorded images are regarded as continuous images in the vicinity of a car accident before (right after the symptom of accident) and after the car accident.

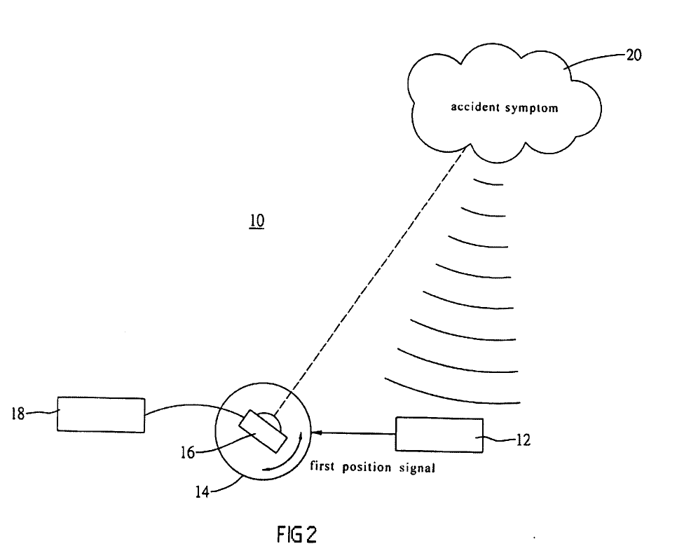

Referring to FIG. 2, the first embodiment of a vehicle recorder 10 of the present invention is illustrated. The vehicle recorder 10 is mounted to a transportation tool for recording continuous images in the vicinity of a car accident before and after the car accident happens such as all the changes of the traffic lights from before till after the car accident. In this way, the continuous images before and after the car accident registered by the vehicle recorder 10 are capable of offering the appraisal institution or the court sufficient evidences before the liability of the car accident being capable of being attributed to the party causing the accident even if no witness gives evidence or the witness is unwilling to give evidence.

The vehicle recorder 10 includes a first accident symptom detector 12, a steering device 14 coupled to the first accident symptom detector 12, an image capturing device 16 mounted to the steering device 14 and coupled to first accident detector 12 and a memory 18 for saving the images.

The first accident symptom detector 12 is used for detecting an accident symptom 20 and generating a first position signal PSI, which is related to position relation between the first accident symptom detector 12 and the accident symptom 20. For instance, the first accident symptom detector 12 can detect noise resulting from frictions of the wheel tires against the ground, the lasting warning sound from horn or objects near the first accident symptom detector 12. It is an extreme possibility that the noise resulting from frictions of the wheel tires against the ground occurs due to a high speed moving vehicle stopping urgently with brakes and it is an extreme possibility too that the lasting sound warned with horn results from a high speed moving car along the road almost hitting a passenger or another car. In case of the sound volume of the noise resulting from frictions of the wheel tires against the ground being detected higher than a predetermined sound volume (equivalently, speed per hour of the car must be higher than a predetermined speed per hour), a duration of the lasting sound warned with the horn being detected longer than a predetermined duration or a distance between an object and the first accident symptom detector 12 being shorter than a predetermined distance (the car mounted with the first accident symptom 12 almost hits the object), the first accident symptom detector 12 generates a first position signal PSI. The first position signal PSI has a positional relation with the first accident symptom detector 12, the car emitting the lasting warning sound or the object almost hit by the car.

The steering device 14 implements a movement of steering in accordance with the first accident symptom detector 12. Due to the image capturing device 16 being mounted to the steering device 14, it is equivalent that the image capturing device 16 is steered during the steering device 14 implementing a movement of steering. The first position signal PSI generated by the first accident symptom detector 12 basically is used to steer the image capturing device 16 facing the accident symptom 20 such that the image capturing device 16 is able to capture images surrounding the accident symptom 20. After receiving the first position signal PSI generated by the first accident symptom detector 12, the image capturing device 16 starts to capture images continuously in predetermined time duration and stores the captured images in the memory 18. The predetermined time duration is 5 to 10 seconds so that it is not necessary for the memory 18 to provide too large the data storage capacity of the memory 18.

Because the image capturing device 16 has been steered to face the accident symptom 20, the captured continuous images definitely are images surrounding the accident symptom 20. As the forgoing, the captured continuous images contain images of changes of the traffic lights right before and after a car accident. In this way, the accident determination institute and the court is capable of deciding the liability of the car accident being attributed to which party.

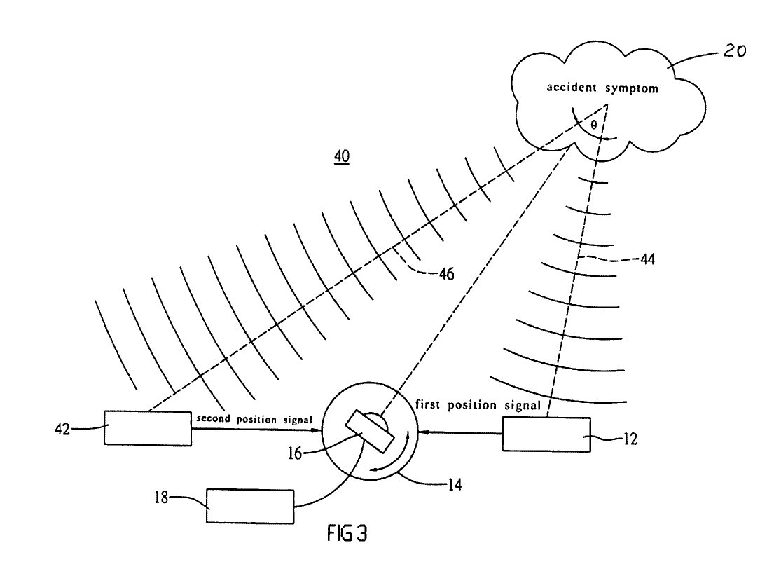

The vehicle recorder 10 provided in the first embodiment of the present invention includes a single accident symptom detector only, i.e., the first accident symptom detector 12 only. Referring to FIGS. 3, the second embodiment of a vehicle recorder 10 of the present invention is illustrated. The vehicle recorder 40 of the second embodiment further includes a second accident symptom detector 42 in addition to the first accident symptom detector 12, the steering device 14, the image capturing device 16 and the memory 18. Similar to the first accident symptom detector 12, the second accident symptom detector 42 is used for detecting the accident symptom 20 and generates a second positional signal PS2. The second position signal PS2 provides position relation of the second accident symptom 42 to the accident symptom 20.

An angle θ between a first straight line 44 connecting the first accident symptom detector 12 to the accident symptom 20 and a second straight line 46 connecting the second accident symptom detector 42 to the accident symptom 20 has a relation to a distance between the accident symptom 20 to the image capturing device 16. That is, the angle θ being greater stands for the distance of the accident symptom 20 to the image capturing device 16 being shorter and vice versa. Hence, the image capturing device 16 is capable of zooming in or out the images based on the second positional signal PS2. In this way, the image capturing device 16 can be operated to zoom out the images in the vicinity of the accident symptom 20 in case of angle θ being small so as to capture clearer images of the accident symptom 20 and to zoom in the images in the vicinity of the accident symptom 20 in case of angle θ being very large so as to capture the entire accident symptom 20.

The vehicle recorders 10, 40 in preceding two embodiments detect the accident symptom 20 passively, that is, the vehicle recorders 10, 40 generate the first and second positional signals PSI, PS2 passively only because the accident symptom 20 has been detected in an environment having the transportation tool. However, the vehicle recorder of the present invention is able to generate a positional signal automatically.

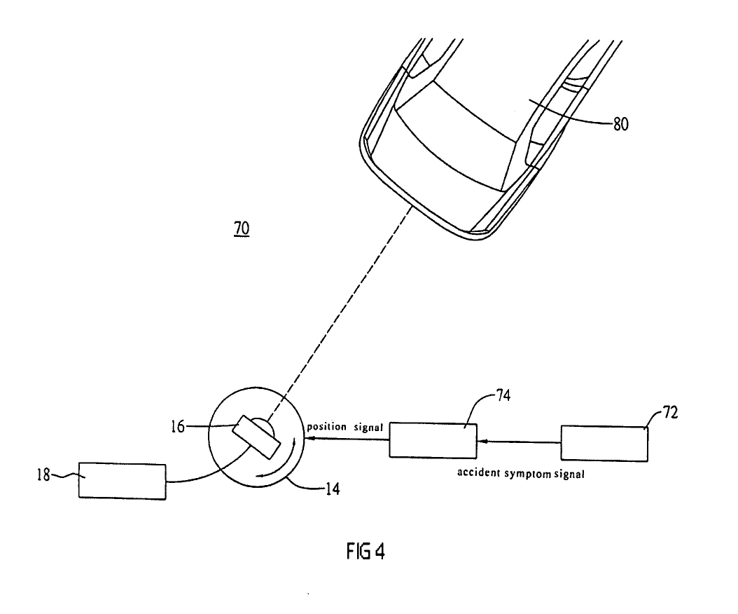

Referring to FIG. 4, a block diagram of functions of the third embodiment of a vehicle recorder 70 according to the present invention is illustrated. The vehicle recorder 70 can be mounted to the transportation tool too. The vehicle recorder 70 of the third embodiment further includes an accident symptom detector 72 and a position detector 74 in addition to the first accident symptom detector 12, the steering device 14, the image capturing device 16 and the memory 18. The function of the first accident symptom detector 12 can be performed by the accident symptom detector 72 and the position detector 74.

Specifically, the accident symptom detector 72 is capable of detecting rotational speeds of the tires or temperatures of the brakes of the transportation tool and generating an accident symptom signal in case of respective change rate of the rotational speeds of the tires being higher than a predetermined change rate or the temperatures of the brakes being higher than a predetermined temperature. It is noted that due to urgently braking, the rotational speeds of the tires reduced to low speeds from high rotational speeds rapidly so that the change rate of the rotational speeds of the tires is extremely possibly higher than the predetermined change rate. The position detector 74 detects an object 80 (probably a car in front of the transportation tool) and generates a position signal PS (similar to the first positional signal) nearest the transportation tool as soon as the accident symptom signal is received by the position detector 74. The position signal PS has a position relation of the object 80 to the position detector 74. By the same token, the steering device 14 implements a movement of steering as soon as the position signal PS is received by the steering device 14 so that the image capturing device 16 is steered to face the object 80. In this way, the image capturing device 16 is able to capture images surrounding the object 80. Of course, the vehicle recorder 70 is able to add another position detector such that the scene surrounding the object 80 can be captured more clearly and completely by the vehicle recorder 70 as recorded images.

Comparing to the prior art, it is appreciated that the vehicle recorder of the present invention is capable of registering continuous images surrounding the scene of a car accident passively or automatically in advance before the car accident happens, i.e., during a accident symptom occurring. In this way, the accident determination institute and the court are capable of deciding the liability of the car accident being attributed to which party according to the continuous images.

While the invention has been described with referencing to preferred embodiments thereof, it is to be understood that modifications or variations may be easily made without departing from the spirit of this invention, which is defined by the appended claims.

What is claimed is:

1. A vehicle recorder to capture continuous images in the vicinity of an accident before and after the accident happens, comprising:
a first accident symptom detector, being used for detecting an accident symptom and generating a first position signal, which provides a positional relation between the first accident symptom detector and the accident symptom;
a steering device, being coupled to the first accident symptom detector for implementing a movement of steering in accordance with the first position signal;
an image capturing device, being mounted to the steering device and coupled to the first accident symptom detector for capturing images continuously in a predetermined time duration; and
a memory, being coupled to the image capturing device for storing the continuous images captured by the image capturing device in the predetermined time duration.

2. The vehicle recorder as defined in claim 1, wherein the first accident symptom detector is a sound detector of tire friction against the ground and the accident symptom is a sound volume of tire friction against the ground greater than a predetermined sound volume.

3. The vehicle recorder as defined in claim 1, wherein the first accident symptom detector is a sound detector of lasting warn of horn and the accident symptom is a time duration of the lasting warn greater than a predetermined time duration allowable for the lasting warn.

4. The vehicle recorder as defined in claim 1, wherein the first accident symptom detector is a distance detecting device and the accident symptom is an object with a distance to first accident symptom detector less than a predetermined distance.

5. The vehicle recorder as defined in claim 1 further comprises:
a second accident symptom detector, being used for detecting an accident symptom and generating a second position signal, which provides a positional relation between the second accident symptom detector and the accident symptom;
wherein, the image capturing device is capable of zooming in and out the images in accordance with the first position signal and the second position signal.

6. A vehicle recorder for a transportation tool to capture continuous images in the vicinity of an accident before and after the accident happens, comprising:
an accident symptom detector, being used for detecting an accident symptom and generating an accident symptom signal;
a position detector, being used for detecting an object nearest the transportation according to the accident symptom signal and generating a position signal, which provides a position relation between the object and the transportation tool;
a steering device, being coupled to the position detector for implementing a movement of steering in accordance with the position signal;
an image capturing device, being mounted to the steering device and coupled to the position detector for capturing images continuously in a predetermined time duration according to the position signal; and
a memory, being coupled to the image capturing device for storing the continuous images captured by the image capturing device in the predetermined time duration.

7. The vehicle recorder as defined in claim 6, wherein the accident symptom detector is a detector for detecting rotational speed of tire of the transportation tool and the accident symptom is a change rate of the rotational speed greater than a predetermined change rate of the rotational speed.

8. The vehicle recorder as defined in claim 6, wherein the accident symptom detector is a temperature sensing device for detecting temperature of brake of the transportation tool and the accident symptom is the temperature greater than a predetermined temperature of brake.
